(19) United States
(12) Patent Application Publication
(10) Pub. No.: US 2007/0218934 A1
(43) Pub. Date: Sep. 20, 2007

(54) Communication Terminal and Transmission Power Control Method

(75) Inventor: Yoshiharu Osaki, Kanagawa (JP)

Correspondence Address: STEVENS, DAVIS, MILLER & MOSHER, LLP, 1615 L. STREET N.W., SUITE 850, WASHINGTON, DC, 20036, US

(73) Assignee: Matsushita Electric Industrial Co., Ltd., Osaka (JP)

(21) Appl. No.: 11/587,341

(22) PCT Filed: Apr. 14, 2005
(86) PCT No.: PCT/JP05/07221

§ 371 Date: Oct. 25, 2006

(30) Foreign Application Priority Data
Apr. 28, 2004 (JP) 2004-134681

(51) Int. Cl. H04B 7/26

(52) U.S. Cl. 455/522

(57) ABSTRACT

A communication terminal which suppresses the interference power to a cell newly appearing on handover in an uplink line. A transmission power calculation section (107) of the communication terminal calculates the transmission power Pₜᵣₐₙₛₘᵢₜ by adding the value specified by a TPC command to the previous transmission power. A reception power measuring section (109) calculates the pilot reception power P_{active} of the cell in communication. A reception power measuring section (110) calculates the pilot reception power Pₒₜₕₑᵣ of a vicinity cell which will probably newly perform communication. A transmission power correction section (111) corrects the transmission power to a value P_{allow} lower than Pₜᵣₐₙₛₘᵢₜ by subtracting (Pₒₜₕₑᵣ−P_{active}) from Pₜᵣₐₙₛₘᵢₜ if the pilot reception power Pₒₜₕₑᵣ is larger than the pilot reception power P_{active}. A transmission power control section (153) controls the transmission power of the transmission signal to P_{allow}.

### TECHNICAL FIELD

The present invention relates to a communication terminal apparatus and transmission power control method used in a radio communication system of a CDMA scheme.

### BACKGROUND ART

A conventional radio communication system of a CDMA scheme uses a method whereby, upon handover, a communication terminal apparatus measures in downlink a reference signal reception level (SIR) of a base station apparatus which is a destination of the handover and controls transmission power of a traffic channel of each base station apparatus according to the level of reference signal SIR of each base station apparatus (for example, see Patent Document 1).

By this means, it is possible to prevent a signal from being transmitted with excessive transmission power upon handover in downlink, so that communication capacity and throughput in downlink can be improved.

Patent Document 1: Japanese Patent Application Laid-Open No. HEI11-308655

### DISCLOSURE OF INVENTION

### Problems to be Solved by the Invention

However, conventionally, specific transmission power control is not performed upon handover in uplink, and thereby, a problem arises that a signal is transmitted with excessive transmission power upon handover transition, and communication capacity and throughput in uplink deteriorate.

Furthermore, in CDMA communication, there is a problem called “corner problem” at a transition state upon handover transition, and a technology to cope with this problem is desired. The corner problem will be explained below. A case is considered where, from the viewpoint of the active communication terminal apparatus, a new cell suddenly appears and the reception power from this cell becomes larger than the reception power from the active cell. In this case, the propagation loss for the active cell is likely to be smaller than the propagation loss for the newly appearing cell. Therefore, since uplink transmission power necessary for communication with the active cell is larger than uplink transmission power necessary for communication with the newly appearing cell, the newly appearing cell receives large interference power. By this means, in uplink of another user which is communicating with the newly appearing cell, communication quality deteriorates substantially or excessive transmission power is required. This is the corner problem.

It is therefore an object of the present invention to provide a communication terminal apparatus and transmission power control method capable of suppressing interference power against a newly appearing cell upon handover transition in uplink.

### Means for Solving the Problem

In order to solve this problem, the transmission power control method of the present invention has: a transmission power calculation step of calculating transmission power by adding a value indicated by a TPC command to previous transmission power; a first reception power measurement step of measuring first reception power that is reception power from an active cell; a second reception power measurement step of measuring second reception power that is reception power from a neighboring cell where communication may be newly performed; a transmission power correction step of calculating correction transmission power by subtracting a difference value between the second reception power and the first reception power from the transmission power when the second reception power is larger than the first reception power; and a transmission power control step of controlling transmission power of a transmission signal to the correction transmission power.

The communication terminal apparatus of the present invention adopts a configuration having: a transmission power calculation section that calculates transmission power by adding a value indicated by a TPC command to previous transmission power; a first reception power measurement section that measures first reception power that is reception power from an active cell; a second reception power measurement section that measures second reception power that is reception power from a neighboring cell where communication may be newly performed; a transmission power correction section that calculates correction transmission power by subtracting a difference value between the second reception power and the first reception power from the transmission power when the second reception power is larger than the first reception power; and a transmission power control section that controls transmission power of a transmission signal to the correction transmission power.

### Advantageous Effect of the Invention

According to the present invention, it is possible to reduce transmission power of the communication terminal apparatus corresponding to the difference between propagation loss with the active cell and the propagation loss with a newly appearing cell, so that, in uplink, it is possible to suppress upon handover transition interference power against a neighboring cell where communication may be newly performed and prevent deterioration of communication quality at the neighboring cell.

### BRIEF DESCRIPTION OF DRAWINGS

FIG. 1 is a block diagram showing a configuration of a communication terminal apparatus according to Embodiment 1 of the present invention;

FIG. 2 illustrates transition of pilot reception power of the active cell and a neighboring cell where communication is newly performed in the communication terminal apparatus;

FIG. 3 is a block diagram showing a configuration of the communication terminal apparatus according to Embodiment 1 of the present invention;

FIG. 4 is a block diagram showing a configuration of the communication terminal apparatus according to Embodiment 2 of the present invention; and

FIG. 5 is a block diagram showing a configuration of the communication terminal apparatus according to Embodiment 3 of the present invention.

### BEST MODE FOR CARRYING OUT THE INVENTION

Embodiments of the present invention will be explained below in detail with reference to the accompanying drawings.

(Embodiment 1)

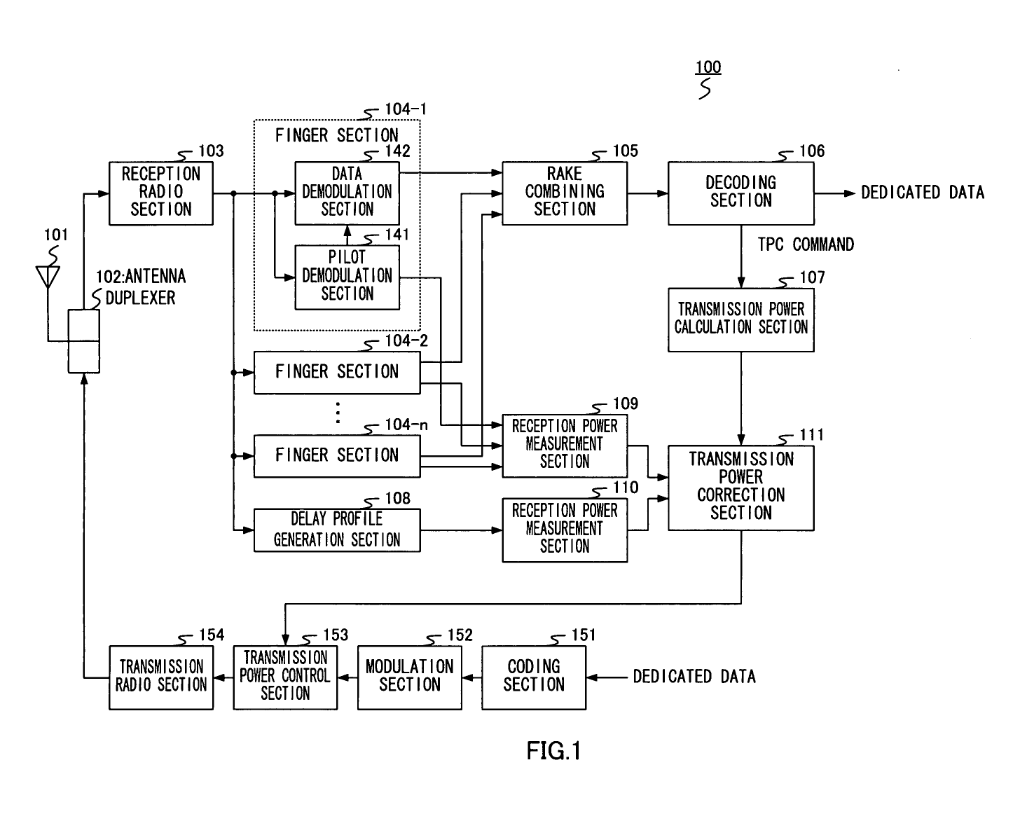

FIG. 1 is a block diagram showing the configuration of the communication terminal apparatus according to Embodiment 1 of the present invention. Communication terminal apparatus 100 in FIG. 1 is mainly configured with antenna 101, antenna duplexer 102, reception radio section 103, finger sections 104-1 to 104-n, RAKE combining section 105, decoding section 106, transmission power calculation section 107, delay profile generation section 108, reception power measurement sections 109 and 110, transmission power correction section 111, coding section 151, modulation section 152, transmission power control section 153 and transmission radio section 154. Further, finger sections 104-1 to 104-n each has pilot demodulation section 141 and data demodulation section 142.

Antenna 101 outputs signals transmitted by radio from neighboring base stations including the active base station to antenna duplexer 102, and transmits by radio transmission signals outputted from antenna duplexer 102 to the active base station. Antenna duplexer 102 outputs signals from neighboring base stations received at antenna 101 to reception radio section 103, and outputs transmission signals outputted from transmission radio section 154 to antenna 101.

Reception radio section 103 performs down-conversion on the output signals of radio frequency from antenna duplexer 102 and outputs the baseband signals to finger sections 104-1 to 104-n and delay profile generation section 108.

Pilot demodulation section 141 of each of finger sections 104-1 to 104-n performs de-spreading processing and demodulation processing on the pilot signal portion of the output signal of radio reception section 103, outputs information of the demodulation timing to data demodulation section 142, and outputs the demodulated pilot signal to reception power measurement section 109. Data demodulation section 142 of each of finger sections 104-1 to 104-n performs de-spreading processing and demodulation processing on the output signal of radio reception section 103 at the demodulation timing of the pilot signal and outputs the demodulated signal to RAKE combining section 105.

RAKE combining section 105 performs RAKE combining with the demodulated signals outputted from finger sections 104-1 to 104-n and outputs the result (RAKE combined signal) todecodingsection106. Decoding section 106 performs decoding processing on the RAKE combined signal outputted from RAKE combining section 105 and obtaining dedicated data. And Decoding section 106 outputs the TPC command obtained by decoding processing to transmission power calculation section 107. Transmission power calculation section 107 adds the value indicated by the TPC command to previous transmission power, calculates transmission power Pₜᵣₐₙₛₘᵢₜ, and outputs the result to transmission power correction section 111.

Delay profile generation section 108 generates the delay profile of reception signals from neighboring cells where communication may be newly performed and outputs information of the delay profile to reception power measurement section 110. Reception power measurement section 109 calculates pilot reception power P_{active} of the active cell by combining the reception powers of the demodulated pilot signals outputted from finger sections 104-1 to 104-n and outputs the result to transmission power correction section 111. Reception power measurement section 110 calculates pilot reception power Pₒₜₕₑᵣ from the neighboring cells where communication may be newly performed based on the information of the delay profile and outputs the result to transmission power correction section 111.

Transmission power correction section 111 calculates allowable transmission power P_{allow} by equation (1) below and outputs the result to transmission power control section 153. As a result, when pilot reception power Pₒₜₕₑᵣ of a neighboring cell is equal to or smaller than pilot reception power P_{active} of the active cell, transmission power is controlled to Pₜᵣₐₙₛₘᵢₜ. And, when pilot reception power Pₒₜₕₑᵣ of the neighboring cell is larger than pilot reception power P_{active} of the active cell, the transmission power is corrected and controlled to a value lower than Pₜᵣₐₙₛₘᵢₜ.
P_{allow}=Pₜᵣₐₙₛₘᵢₜ−[MAX(0,Pₒₜₕₑᵣ−P_{active})](1)

Coding section 151 performs coding processing on dedicated data to be transmitted and outputs the coded signal to modulation section 152. Modulation section 152 performs modulation processing and spreading processing on the output signal of coding section 151 and outputs the result to transmission power control section 153. Transmission power control section 153 controls transmission power of the output signal of modulation section 152 to P_{allow} and outputs the result to transmission radio section 154. Transmission radio section 154 performs up-conversion on the baseband output signal of transmission power control section 153 and outputs a radio frequency signal to antenna duplexer 102.

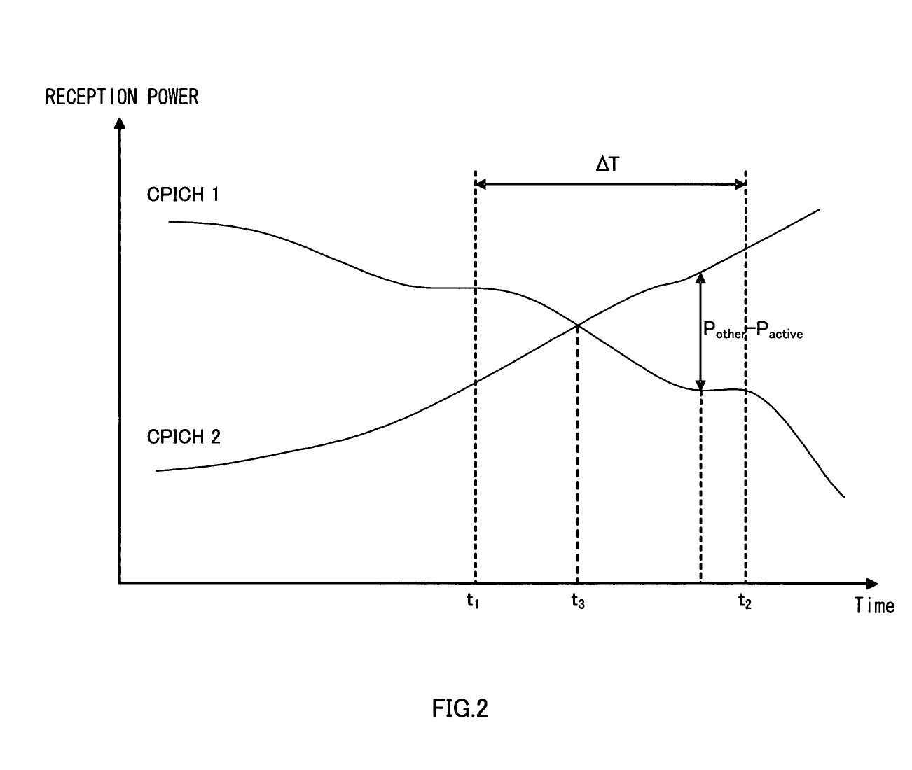

Next, a transmission power control method of communication terminal apparatus 100 in FIG. 1 will be explained using FIG. 2. FIG. 2 illustrates transition of pilot (CPICH 1) reception power P_{active} of active cell 1 and pilot (CPICH 2) reception power Pₒₜₕₑᵣ of neighboring cell 2 where communication is newly performed. In FIG. 2, communication terminal apparatus 100 transmits at time t₁ a request to “add cell 2 as active cell for handover” to a network control apparatus (not shown) that is a higher apparatus of the base station apparatus. Control delay period ΔT is required until the handover actually starts from this request. At time t₂ (after control delay period ΔT), communication starts at the same time with the two cells (usually it is called “soft handover”) , and transmission power of the communication terminal apparatus is appropriately controlled by transmission power control of cell 2. However, although Pₒₜₕₑᵣ is larger than P_{active} during a period from time t₃ to time t₂, transmission power of the communication terminal apparatus is controlled by transmission power control of cell 1, and therefore interference becomes large in cell 2 unless some kind of correction is made to the transmission power.

In this Embodiment, the difference (Pₒₜₕₑᵣ−P_{active}) of pilot reception powers is equivalent to the difference of propagation losses of cell 1 and cell 2. Therefore, during the period from time t₃ to time t₂, communication terminal apparatus 100 corrects transmission power by subtracting (Pₒₜₕₑᵣ−P_{active}) from calculated transmission power Pₜᵣₐₙₛₘᵢₜ, and transmits a signal with the corrected transmission power P_{allow}. By this control, the reception power of cell 2 decreases corresponding to the propagation loss with cell 1, so that reception power of cell 2 is suppressed to equivalent power to the reception power expected at cell 1 by this transmission power control.

In this way, according to this Embodiment, transmission power of the communication terminal apparatus can be reduced corresponding to the difference between the propagation loss with the active cell and the propagation loss with the newly appearing neighboring cell, so that, in uplink, it is possible to suppress upon interference power against the neighboring cell which newly appears at handover transition and cope with the corner problem.

In this Embodiment, propagation loss is calculated from pilot transmission power broadcasted from the cells, and transmission power P_{allow} that can be allowed can be determined by equation (2) below. In equation (2), L_{active} indicates propagation loss of the active cell, and Lₒₜₕₑᵣ indicates propagation loss of a neighboring cell.
P_{allow}=Pₜᵣₐₙₛₘᵢₜ−[MAX(0, L_{active}−Lₒₜₕₑᵣ)](2)

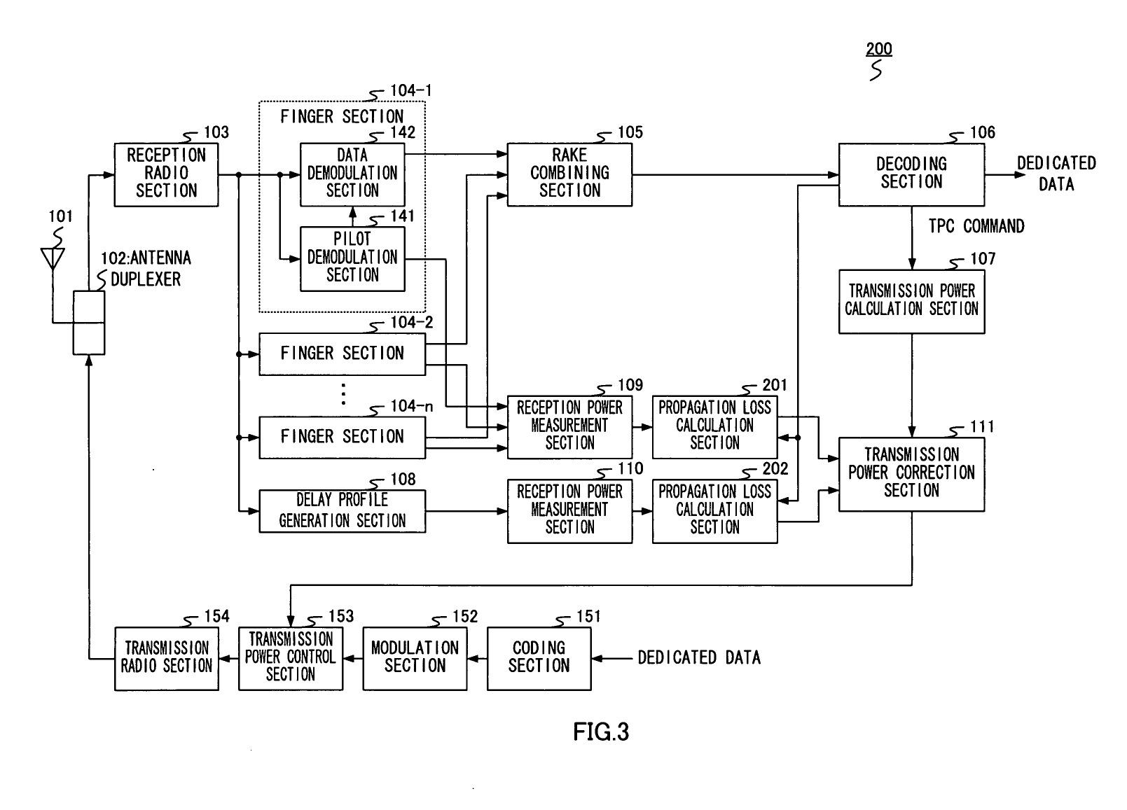

FIG. 3 is a block diagram showing the configuration of the communication terminal apparatus in this case. Communication terminal apparatus 200 in FIG. 3 adopts a configuration adding propagation loss calculation sections 201 and 202 compared to communication terminal apparatus 100 shown in FIG. 1.

Decoding section 106 outputs information indicating pilot transmission power broadcasted from decoded cells to propagation loss calculation sections 201 and 202. Propagation loss calculation section 201 subtracts pilot reception power P_{active} of the active cell from pilot transmission power of the active cell to calculate propagation loss L_{active} of the active cell and outputs the result (L_{active}) to transmission power correction section 111. Propagation loss calculation section 202 subtracts pilot reception power Pₒₜₕₑᵣ of the neighboring cell from pilot transmission power of the neighboring cell to calculate propagation loss Lₒₜₕₑᵣ of the neighboring cell and outputs the result (Lₒₜₕₑᵣ) to transmission power correction section 111. Transmission power correction section 111 calculates allowable transmission power P_{allow} from equation (2) and outputs the result to transmission power control section 153.

(Embodiment 2)

A case has been described in Embodiment 1 where calculated transmission power is uniformly corrected and controlled, but a case will be described in Embodiment 2 where only transmission power of a specific channel is controlled.

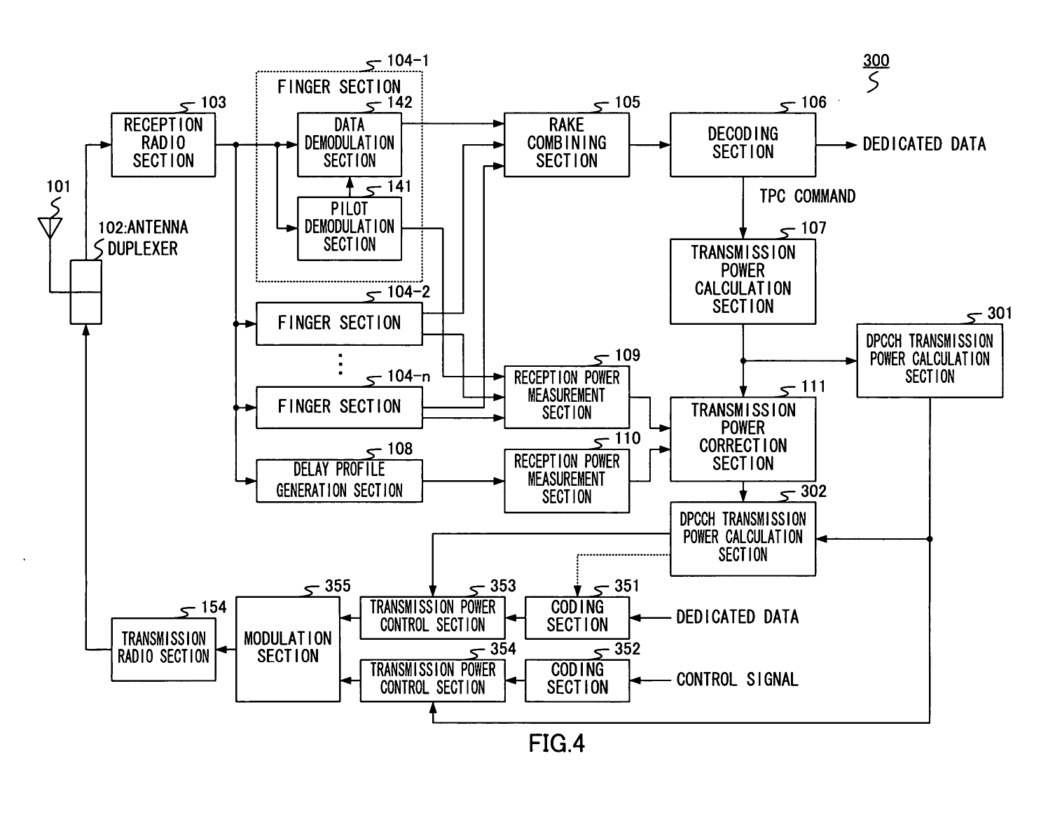

FIG. 4 is a block diagram showing a configuration of the communication terminal apparatus according to Embodiment 2 of the present invention. In addition, components of communication terminal apparatus 300 shown in FIG. 4 that are common with communication terminal apparatus 100 shown in FIG. 1 will be assigned the same reference numerals as in FIG. 1 without further explanations.

Compared to communication terminal apparatus 100 shown in FIG. 1, communication terminal apparatus 300 shown in FIG. 4 adopts a configuration removing coding section 151, modulation section 152 and transmission power control section 153, and adding DPCCH transmission power calculation section 301, DPDCH transmission power calculation section 302, coding sections 351 and 352, transmission power control sections 353 and 354 and modulation section 355.

Transmission power calculation section 107 calculates transmission power Pₜᵣₐₙₛₘᵢₜ by adding the value indicated by the TPC command to previous transmission power and outputs the result (Pₜᵣₐₙₛₘᵢₜ) to transmission power correction section 111 and DPCCH transmission power calculation section 301.

DPCCH transmission power calculation section 301 calculates transmission power PDPCCH of DPCCH by multiplying Pₜᵣₐₙₛₘᵢₜ by a ratio (DPCCH/DPDCH) between dedicated control channel (DPCCH) specified in advance and dedicated data channel (DPDCH) and outputs the result (P_{DPCCH}) to DPDCH transmission power calculation section 302 and transmission power control section 354.

Transmission power correction section 111 calculates allowable transmission power P_{allow} based on equation (1) and outputs the result (P_{allow}) to DPDCH transmission power calculation section 302.

DPDCH transmission power calculation section 302 calculates transmission power P_{DPDCH} of DPDCH by subtracting P_{DPCCH} from P_{allow} and outputs the result (PDPDCH) to coding section 351 and transmission power control section 353.

Coding section 351 performs coding processing on dedicated data to be transmitted and outputs the coded signal to transmission power control section 353. In addition, coding section 351 can select a coding method according to a ratio (DPCCH/DPDCH) between transmission power P_{DPCCH} of DPCCH and transmission power P_{DPDCH} of DPDCH. Coding section 352 performs coding processing on a dedicated control signal to be transmitted and outputs the coded signal to transmission power control section 354.

Transmission power control section 353 controls transmission power of the output signal of coding section 351 to P_{DPDCH} and outputs the result to modulation section 355. Transmission power control section 354 controls transmission power of the output signal of coding section 352 to P_{DPCCH} and outputs the result to modulation section 355.

Modulation section 355 multiplexes the output signal of transmission power control section 353 and the output signal of transmission power control section 354, performs modulation processing and spreading processing on the multiplexed signal, and outputs the result to transmission radio section 154.

In this way, according to this embodiment, when transmission power is corrected, only transmission power of a specific channel can be controlled, so that it is possible to maintain transmission power of an important channel (for example, dedicated control channel) compared to the other channels and maintain link connection.

(Embodiment 3)

A case will be described in Embodiment 3 where, in a radio communication scheme performing high-speed packet transmission in uplink, only transmission power of a packet channel (E-UDCH) is controlled.

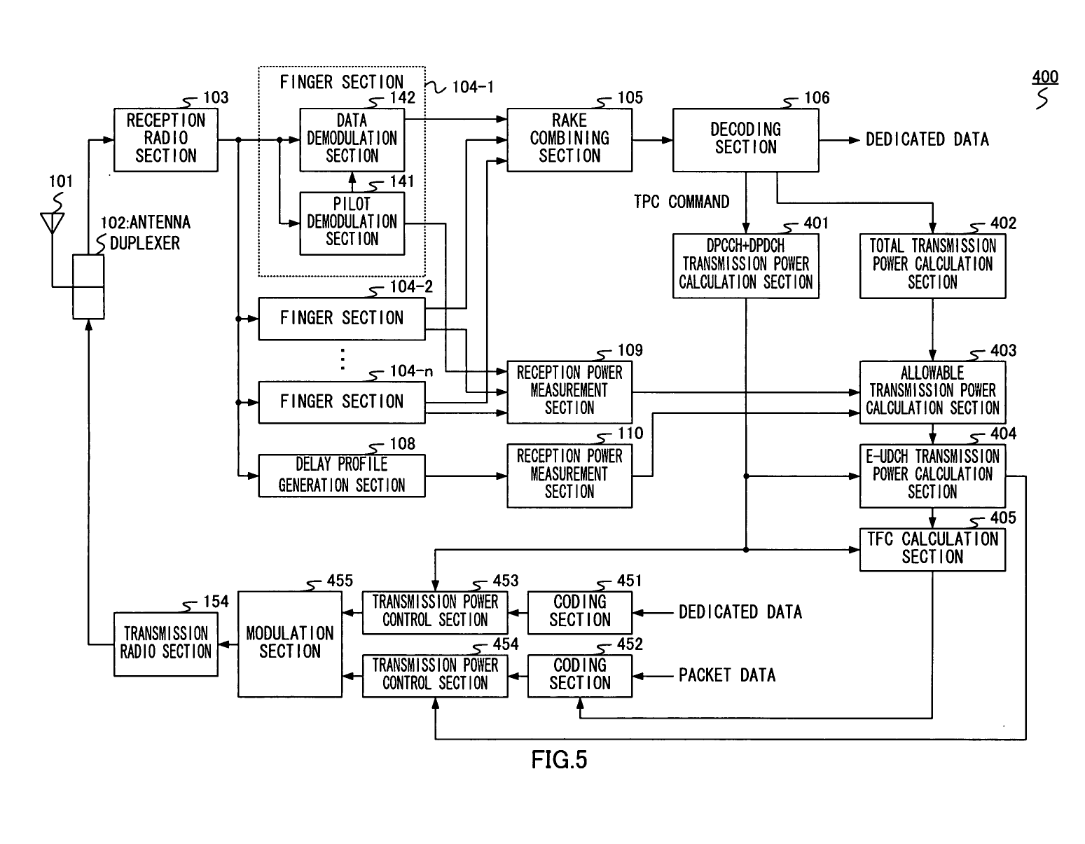

FIG. 5 is a block diagram showing the configuration of the communication terminal apparatus according to Embodiment 3 of the present invention. In addition, components of communication terminal apparatus 400 shown in FIG. 5 that are common with communication terminal apparatus 100 shown in FIG. 1 will be assigned the same reference numerals as in FIG. 1 without further explanations.

Compared to communication terminal apparatus 100 shown in FIG. 1, communication terminal apparatus 400 shown in FIG. 5 adopts a configuration removing coding section 151, modulation section 152 and transmission power control section 153, and adding DPCCH+DPDCH transmission power calculation section 401, total transmission power calculation section 402, allowable transmission power calculation section 403, E-UDCH transmission power calculation section 404, TFC calculation section 405, coding sections 451 and 452, transmission power control sections 453 and 454 and modulation section 455.

DPCCH+DPDCH transmission power calculation section 401 calculates DPCCH+DPDCH transmission power by adding the value indicated by the TPC command to previous transmission power and outputs the result to E-UDCH transmission power calculation section 404, TFC calculation section 405 and transmission power control section 453.

Total transmission power calculation section 402 calculates transmission power Pₜᵣₐₙₛₘᵢₜ in response to a transmittable power indication given from the base station and outputs the result (Pₜᵣₐₙₛₘᵢₜ) to allowable transmission power calculation section 403. The transmittable power indication from the base station is expressed by, for example, a relative value to the current transmission power or absolute value.

Allowable transmission power calculation section 403 calculates allowable transmission power P_{allow} from equation (1) and outputs the result (P_{allow}) to E-UDCH transmission power calculation section 404.

E-UDCH transmission power calculation section 404 calculates transmission power P_{E-UDCH} of E-UDCH by equation (3) and outputs the result (P_{E-UDCH}) to TFC calculation section 405 and transmission power control section 454.
P_{E-UDCH}=P_{allow}−P_{DPCCH+DPDCH} (3)

TFC calculation section 405 selects a coding method according to a ratio between DPCCH transmission power and E-UDCH transmission power P_{E-UDCH} and outputs information indicating the selected coding method to coding section 452.

Coding section 451 performs coding processing on dedicated data to be transmitted and outputs the coded signal to transmission power control section 453. Coding section 452 performs coding processing on packet data to be transmitted and outputs the coded signal to transmission power control section 454.

Transmission power control section 453 controls transmission power of the output signal of coding section 451 to Pₜᵣₐₙₛₘᵢₜ and outputs the result to modulation section 455. Transmission power control section 454 controls transmission power of the output signal of coding section 452 to P_{E-UDCH} and outputs the result to modulation section 455.

Modulation section 455 multiplexes the output signal of transmission power control section 453 and the output signal of transmission power control section 454, performs modulation processing and spreading processing on the multiplexed signal, and outputs the result to transmission radio section 154.

In this way, according to this embodiment, when transmission power is corrected in a radio communication scheme performing high-speed packet transmission in uplink, only transmission power of a packet channel can be controlled.

In addition, in the above-described embodiments, by measuring power of the pilot channel in time division between the active cell and another cell, it is possible to share the delay profile measurement system.

The present application is based on Japanese Patent Application No. 2004-134681, filed on Apr. 28, 2004, the entire content of which is expressly incorporated herein by reference.

### INDUSTRIAL APPLICABILITY

The present invention is suitable for use in a communication terminal apparatus used in a radio communication system of a CDMA scheme.

1. A transmission power control method comprising:
a transmission power calculation step of calculating transmission power by adding a value indicated by a TPC command to previous transmission power;
a first reception power measurement step of measuring first reception power comprising reception power from an active cell;
a second reception power measurement step of measuring second reception power comprising reception power from a neighboring cell where communication may be newly performed;
a transmission power correction step of calculating correction transmission power by subtracting a difference value between the second reception power and the first reception power from the transmission power when the second reception power is larger than the first reception power; and
a transmission power control step of controlling transmission power of a transmission signal to the correction transmission power.

2. A transmission power control method comprising:
a transmission power calculation step of calculating transmission power by adding a value indicated by a TPC command to previous transmission power;
a first reception power measurement step of measuring first reception power comprising reception power from an active cell;
a second reception power measurement step of measuring second reception power comprising reception power from a neighboring cell where communication may be newly performed;
a first propagation loss calculation step of calculating first propagation loss by subtracting the first reception power from transmission power of the active cell;
a second propagation loss calculation step of calculating second propagation loss by subtracting the second reception power from transmission power of the neighboring cell;
a transmission power correction step of calculating correction transmission power by subtracting a difference value between the first propagation loss and the second propagation loss from the transmission power when the first propagation loss is larger than the second propagation loss; and
a transmission power control step of controlling transmission power of a transmission signal to the correction transmission power.

3. A transmission power control method comprising:
a transmission power calculation step of calculating transmission power by adding a value indicated by a TPC command to previous transmission power;
a first channel transmission power calculation step of calculating transmission power of a first channel by multiplying the transmission power by a predetermined transmission power ratio between the first channel and a second channel;
a first reception power measurement step of measuring first reception power comprising reception power from an active cell;
a second reception power measurement step of measuring second reception power comprising reception power from a neighboring cell where communication may be newly performed;
a transmission power correction step of calculating allowable transmission power by subtracting a difference value between the second reception power and the first reception power from the transmission power when the second reception power is larger than the first reception power;
a second channel transmission power calculation step of calculating transmission power of a second channel by subtracting transmission power of the first channel from the allowable transmission power;
a first channel transmission power control step of controlling transmission power of a transmission signal of the first channel to transmission power of the first channel; and
a second channel transmission power control step of controlling transmission power of a transmission signal of a second channel to transmission power of the second channel.

4. A transmission power control method comprising:
a dedicated channel transmission power calculation step of calculating transmission power of a dedicated channel by adding a value indicated by a TPC command to previous transmission power;
a transmission power calculation step of calculating a maximum transmission power value based on a transmittable power indication given from an active cell;
a step of measuring first reception power comprising reception power of the active cell;
a step of measuring second reception power comprising reception power from a neighboring cell where communication may be newly performed;
a step of calculating correction transmission power by subtracting a difference value between the second reception power and the first reception power from the maximum transmission power value when the second reception power is larger than the first reception power;
a step of calculating transmission power of a packet channel by subtracting transmission power of a dedicated channel from the correction transmission power;
a dedicated channel transmission power control step of controlling transmission power of a transmission signal of a dedicated channel to transmission power of the dedicated channel; and
a packet channel transmission power control step of controlling transmission power of a transmission signal of a packet channel to transmission power of the packet channel.

5. A communication terminal apparatus comprising:
a transmission power calculation section that calculates transmission power by adding a value indicated by the TPC command to previous transmission power;
a first reception power measurement section that measures first reception power comprising reception power from an active cell;
a second reception power measurement section that measures second reception power comprising reception power from a neighboring cell where communication may be newly performed;
a transmission power correction section that calculates correction transmission power by subtracting a difference value between the second reception power and the first reception power from the transmission power when the second reception power is larger than the first reception power; and
a transmission power control section that controls transmission power of a transmission signal to the correction transmission power.
